(19) United States
(12) Patent Application Publication
(10) Pub. No.: US 2015/0166125 A1
(43) Pub. Date: Jun. 18, 2015

(54) TOP LIFT TRAILERS

(71) Applicants: Hyundai Translead, San Diego, CA (US); Top Lift Trailers, Boerne, TX (US)

(72) Inventors: Jong Seog Lee, San Diego, CA (US); Merrill J. Stokes, San Diego, CA (US)

(21) Appl. No.: 14/542,335

(22) Filed: Nov. 14, 2014

Related U.S. Application Data
(60) Provisional application No. 61/904,388, filed on Nov. 14, 2013.

(51) Int. Cl. B62D 33/04

(52) U.S. Cl. CPC B62D 33/04

(57) ABSTRACT

A top lift system for a trailer, the top lift system including: a plurality of reinforcement beams integrated to exterior of the trailer; and a plurality of casting structures coupled to the plurality of reinforcement beams, each casting structure including a top opening to receive a first lifting device and a side opening to receive a second lifting device.

### CROSS-REFERENCE TO RELATED APPLICATIONS

This application claims the benefit of priority under 35 U.S.C. §119(e) of co-pending U.S. Provisional Patent Application No. 61/904,388, filed Nov. 14, 2013, entitled “Top Lift Trailer.” The disclosure of the above-referenced application is incorporated herein by reference.

### BACKGROUND

1. Field of the Invention

The present invention relates to truck trailers, and more specifically, to a top lift system for the truck trailers.

2. Background

Different types of trailer rigs are used for over the road movement of goods and products in interstate commerce. Goods and products are also shipped from one place to another in cargo containers or even in trailer rigs mounted on railroad flat cars. Further, the containers and/or trailer rigs may be transferred from flat cars into holds of ships for transportation of goods and products to overseas destinations. To handle a diverse array of goods and products at a minimum cost and greatest economic benefit in shipment from one section of the country to another, or overseas, it is necessary to transfer truck trailers and/or containers intermodally, or from road to rail car, or vice versa.

FIG. 1 shows a conventional trailer 120 (and/or container) being lifted onto transport means 100 such as a train or ship by having a grappling arm 110 and hook apparatus draped and attached over and about the truck trailer 120 in order to lift it from a roadway and place it on the transport means 100 (e.g., a railroad flat car). However, the need to attach grapple hooks to a bottom side of a trailer is inefficient and time consuming. Furthermore, lifting the trailers using the grappling arms can cause damage to sides and bottom (even the top) of the trailers.

### SUMMARY

The present invention provides for top lifting of trailers.

In one implementation, x is disclosed. The system includes: a plurality of reinforcement beams integrated to exterior of the trailer; and a plurality of casting structures coupled to the plurality of reinforcement beams, each casting structure including a top opening to receive a first lifting device and a side opening to receive a second lifting device.

In another implementation, an apparatus for top lifting of trailers is disclosed. The apparatus includes: means for reinforcing an integrity of the trailer attached to exterior of the trailer; and means for receiving a first lifting device from the top and a second lifting device from the side coupled to the means for reinforcing.

Other features and advantages of the present invention should be apparent from the present description which illustrates, by way of example, aspects of the invention.

### BRIEF DESCRIPTION OF THE DRAWINGS

The details of the present invention, both as to its structure and operation, may be gleaned in part by study of the appended further drawings, in which like reference numerals refer to like parts, and in which:

FIG. 1 shows a conventional trailer being lifted onto transport means using a grappling arm;

FIG. 2 is a top view of a top-lifting trailer configured in accordance with one embodiment of the present disclosure;

FIG. 3 is a side view of the top-lifting trailer configured in accordance with another embodiment of the present disclosure;

FIG. 4 is a partial top view the top-lifting trailer showing the detailed view of the steel reinforcement beam integrated into the exterior of the trailer on the ceiling;

FIG. 5 is a partial side view the top-lifting trailer showing the detailed view of the steel reinforcement beam integrated into the exterior of the trailer on the right side;

FIG. 6A shows the single structure configured to receive the top lifting devices in accordance with one embodiment of the present disclosure;

FIG. 6B shows a casting structure configured as a two-unit structure in accordance with another embodiment of the present disclosure;

FIG. 7 is a single-unit structure of the front portion of the trailer in accordance with one embodiment of the present disclosure;

FIG. 8 is a single-unit structure of the rear portion of the trailer in accordance with one embodiment of the present disclosure; and

FIG. 9 is a perspective view of a top lift trailer being lifted by top lift devices in accordance with one embodiment of the present disclosure.

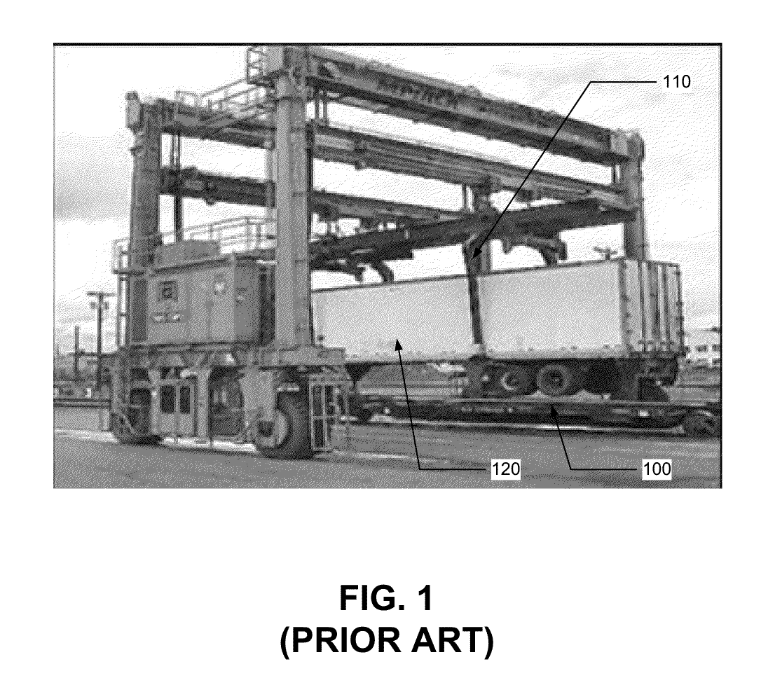

### DETAILED DESCRIPTION

In an effort to achieve maximum strength at minimum weight, the trailers (sometimes referred to as “trailer rigs”) are typically made of steel frames and aluminum skins. Load-bearing steel reinforcement beams are integrated into the exterior of the trailer in the walls, ceiling, and floor at certain industry-recognized locations along the lengths of the trailers. These reinforcement beams provide the necessary strength to allow the trailers to be lifted and/or stacked on top of each other. The reinforcement beams are comprised of side posts integrated into the trailer walls, headers integrated into the trailer ceilings, and footers integrated into the trailer floors. However, the desire to pack increased volumes of cargo into a trailer has led to an evolutionary increase in the length and width of trailers. For example, trailers have increased from a length of 40′ and width of 96″ to lengths as long as 53′ and widths as wide as 102″. Although larger trailers are able to hold a greater volume of cargo, significant structural problems arise when lifting the larger trailers.

Certain embodiments as described herein provide for top lifting of the trailers which provides less damage to the trailers and less operational process at the loading terminals than the grappling arms lifting process. In one embodiment, castings that enable the top lifting include a combination of top castings (e.g., wide top picks) and side castings (e.g., side pin). In another embodiment, the larger trailers are provided with additional reinforcement of the trailer body. After reading this description it will become apparent how to implement the invention in various implementations and applications. However, although various implementations of the present invention will be described herein, it is understood that these implementations are presented by way of example only, and not limitation. As such, this detailed description of various implementations should not be construed to limit the scope or breadth of the present disclosure.

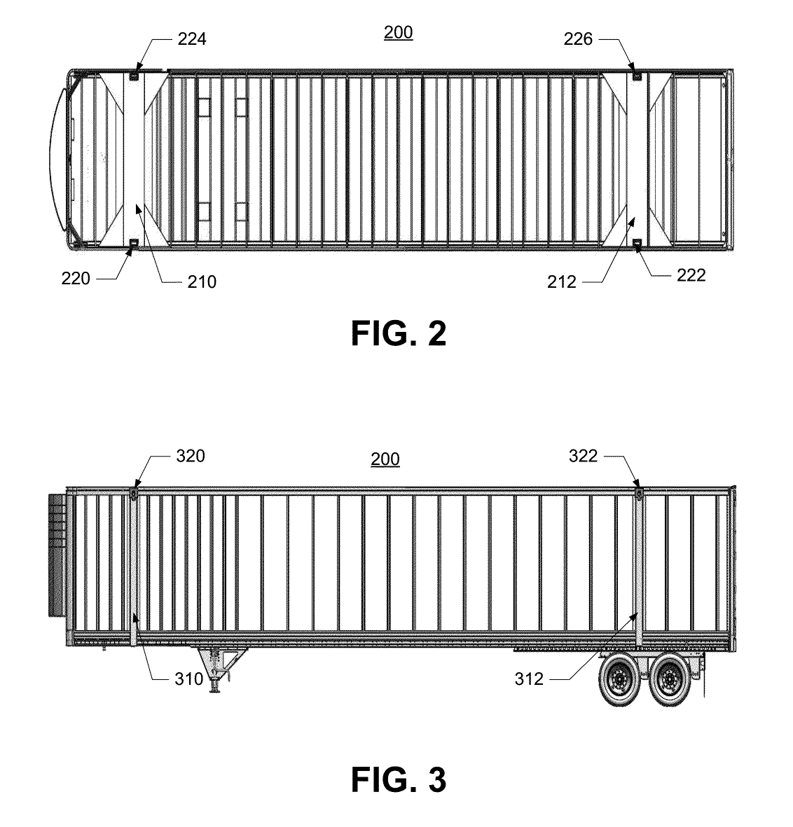

FIG. 2 is a top view of a top-lifting trailer 200 configured in accordance with one embodiment of the present disclosure. The illustrated embodiment of FIG. 2 shows the steel reinforcement beams 210, 212 integrated into the exterior of the trailer on the ceiling at industry-recognized locations along the length of the trailer 200. These reinforcement beams 210, 212 provide the necessary strength to allow the trailer 200 to be lifted from the top.

Lifting points for the trailers are generally located at or near the roof corners of the trailers. The corner top castings have the benefit of two intersecting walls for support, namely the adjoining side wall and the end wall. In addition, the interconnection of a horizontal support between these top castings and a vertical post located at the intersection of the two walls aids in the structural integrity of the trailer 200. In FIG. 2, the front top castings 220, 224 and the rear top castings 222, 226 are shaped to receive the top lifting devices from the top.

FIG. 3 is a side view of the top-lifting trailer 200 configured in accordance with another embodiment of the present disclosure. The illustrated embodiment of FIG. 3 shows the steel reinforcement beams 310, 312 integrated into the exterior of the trailer on the side wall. These reinforcement beams 310, 312 provide the necessary strength to allow the trailer 200 to be lifted from the top. The front side casting 320 and the rear side casting 322 are shaped to receive the top lifting devices from the side.

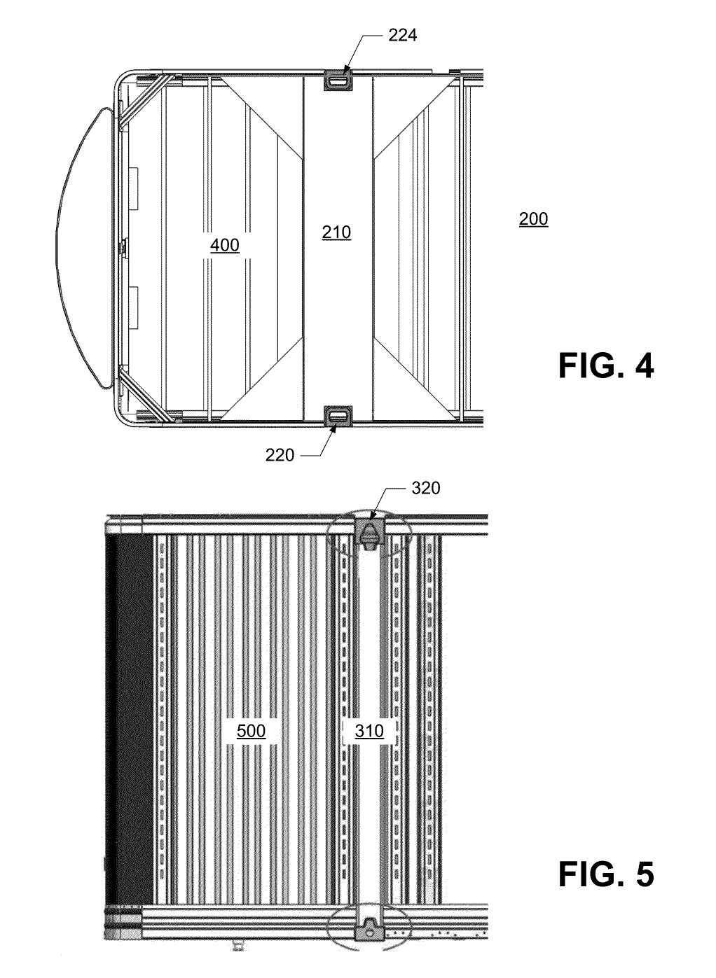

FIG. 4 is a partial top view the top-lifting trailer 200 showing the detailed view of the steel reinforcement beam 210 integrated into the exterior of the trailer on the ceiling 400. FIG. 4 also shows the front top castings 220 shaped to receive the top lifting devices from the top.

FIG. 5 is a partial side view the top-lifting trailer 200 showing the detailed view of the steel reinforcement beam 310 integrated into the exterior of the trailer on the right side 500. FIG. 5 also shows the front side casting 320 shaped to receive the top lifting devices from the side.

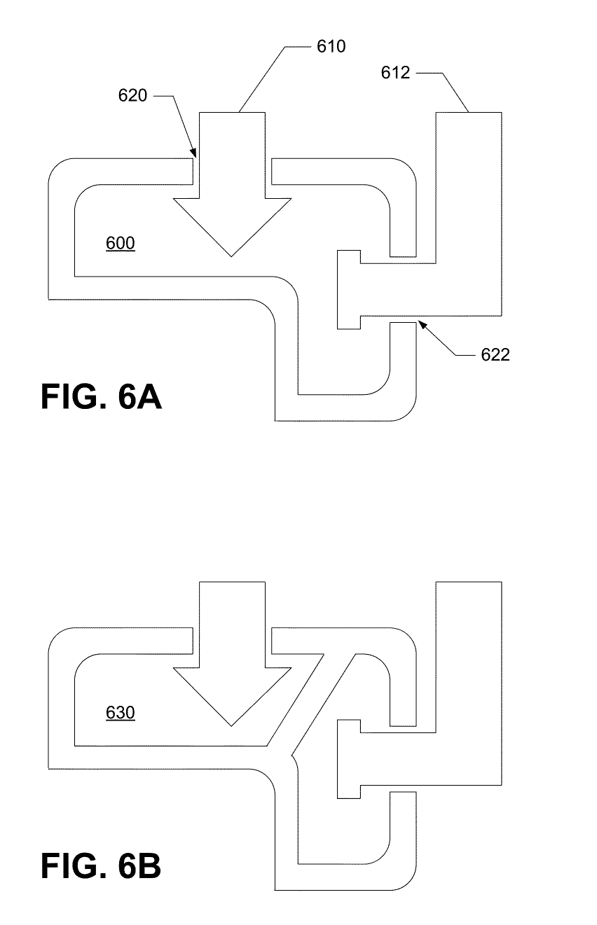

The castings 220 and 320 (as shown in FIGS. 4 and 5, respectively) can be configured as a single structure so that the top lifting devices can be inserted into the top casting 220 and the side casting 320. FIG. 6A shows the single structure 600 configured to receive the top lifting devices 610, 612 in accordance with one embodiment of the present disclosure. In the illustrated embodiment of FIG. 6A, the castings 220 and 320 are configured as a single structure 600 so that the top lifting devices 610, 612 can be inserted into a first opening 620 provided by the top casting 220 and a second opening 622 provided by the side casting 320. In one embodiment, after the lifting devices 610, 612 are inserted into the top and side castings, the lifting devices 610, 612 are then rotated to locking positions. Once all top-lifting devices are locked to into their respective castings, the crane can begin the lifting operations. FIG. 6B shows a casting structure 630 configured as a two-unit structure in accordance with another embodiment of the present disclosure.

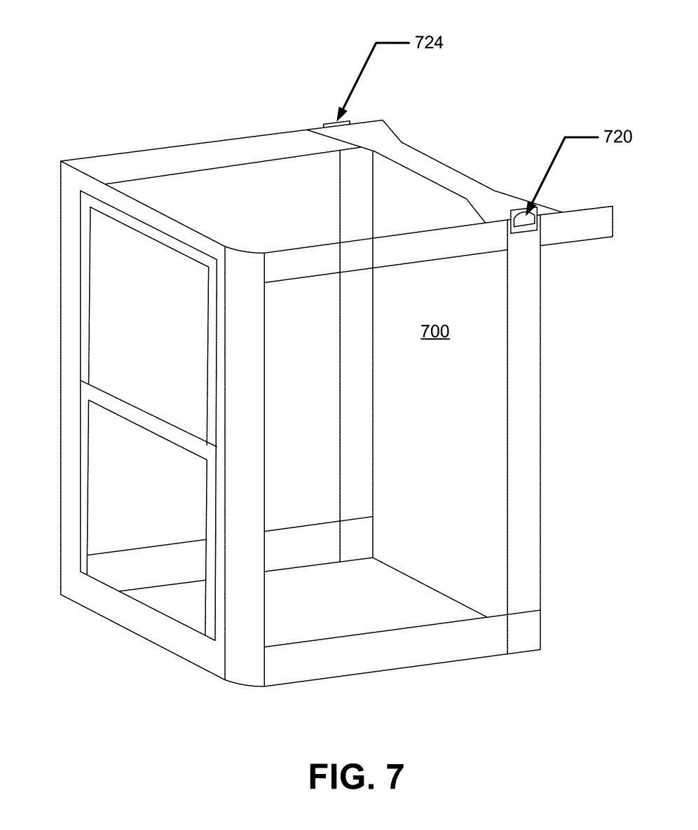

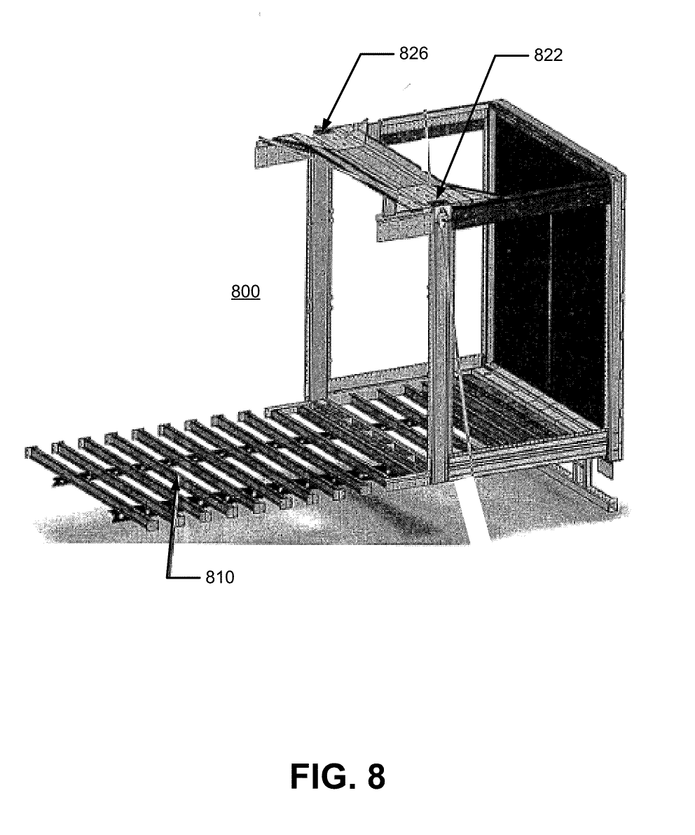

Although larger trailers are able to hold a greater volume of cargo, significant structural problems can arise when lifting the larger trailers. The top lifting configurations of the trailer shown in FIGS. 2-6 provide much stronger pull with a greater chance for maintaining the structural integrity of the trailer. FIGS. 7 and 8 provide further strength to the structural integrity of the trailer.

FIG. 7 is a single-unit structure 700 of the front portion (referred to as a front module frame) of the trailer in accordance with one embodiment of the present disclosure. In the illustrated embodiment of FIG. 7, the structure 700 is constructed as a single unit so that when the trailer 200 (see FIGS. 2 and 3) is top lifted using the castings 710, 712, the structural integrity of the structure 700 can be maintained.

FIG. 8 is a single-unit structure 800 of the rear portion (referred to as a rear module frame) of the trailer in accordance with one embodiment of the present disclosure. In the illustrated embodiment of FIG. 8, the structure 800 is constructed as a single unit so that when the trailer 200 (see FIGS. 2 and 3) is top lifted using the castings 822, 826, the structural integrity of the structure 800 can be maintained.

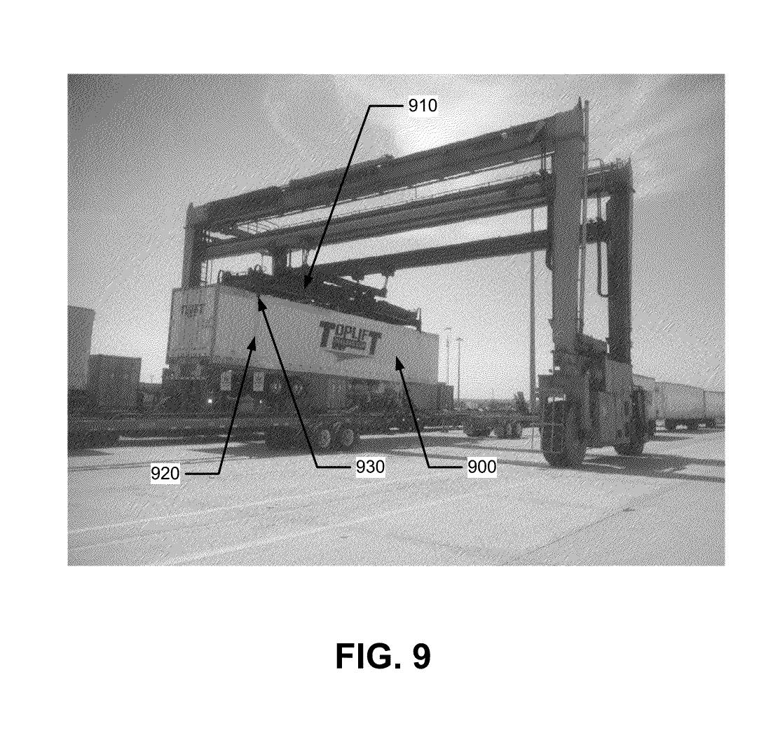

FIG. 9 is a perspective view of a top lift trailer 900 being lifted by top lift devices 910 in accordance with one embodiment of the present disclosure. As stated above, the top lift trailer 900 includes steel reinforcement beams 920 integrated into the exterior of the trailer and a single structure casting 930 including top and side castings to enable top and side lifting. Further, the top lift trailer 900 includes two single-unit structures integrated into the trailer to provide good structural integrity.

The above description of the disclosed implementations is provided to enable any person skilled in the art to make or use the invention. Various modifications to these implementations will be readily apparent to those skilled in the art, and the generic principles described herein can be applied to other embodiments without departing from the spirit or scope of the invention. For example, the top-lift trailer in the illustrated embodiments includes a plurality of casting structures at or near the roof corners configured to receive the top lifting devices from the top and sides. However, the casting structures can be placed on the middle of the sides of the trailer. Thus, it is to be understood that the description and drawings presented herein represent a presently preferred embodiment of the invention and are therefore representative of the subject matter that is broadly contemplated by the present invention. It is further understood that the scope of the present invention fully encompasses other embodiments that may become obvious to those skilled in the art and that the scope of the present invention is accordingly limited by nothing other than the appended claims.

1. A top lift system for a trailer, the top lift system comprising:
a plurality of reinforcement beams integrated to exterior of the trailer; and
a plurality of casting structures coupled to the plurality of reinforcement beams, each casting structure including a top opening to receive a first lifting device and a side opening to receive a second lifting device.

2. The system of claim 1, wherein the plurality of casting structures is placed at or near roof corners of the trailer.

3. The system of claim 1, wherein said each casting structure is configured as a single unit structure.

4. The system of claim 1, wherein said each casting structure is configured as a two unit structure.

5. The system of claim 1, further comprising
a front module frame configured as a first single unit structure.

6. The system of claim 5, further comprising
a rear module frame coupled to the front module frame and configured to as a second single unit structure.

7. An apparatus for top lifting a trailer, the apparatus comprising:
means for reinforcing an integrity of the trailer attached to exterior of the trailer; and
means for receiving a first lifting device from the top and a second lifting device from the side coupled to the means for reinforcing.

8. The apparatus of claim 7, wherein the means for receiving is placed at or near roof corners of the trailer.

9. The apparatus of claim 7, wherein the means for receiving is configured as a single unit structure.

10. The apparatus of claim 7, wherein the means for receiving is configured as a two unit structure.

11. The apparatus of claim 7, further comprising
means for providing a front frame of the trailer configured as a first single unit structure.

12. The apparatus of claim 11, further comprising
means for providing a rear frame of the trailer coupled to the means for providing a front frame of the trailer, the means for providing a rear frame is configured as a second single unit structure.
